(19) United States
(12) Patent Application Publication
(10) Pub. No.: US 2008/0216103 A1
(43) Pub. Date: Sep. 4, 2008

(54) Disk Drive Unit Having an Improved Disk Centring

(75) Inventor: Johannes Martinus Maria Hensing, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,695

(22) PCT Filed: Jul. 6, 2006
(86) PCT No.: PCT/IB2006/052274

§ 371 Date: Jan. 15, 2008

(30) Foreign Application Priority Data
Jul. 18, 2005 (EP) 05106570.4

(51) Int. Cl. G11B 17/03

(52) U.S. Cl. 720/600

(57) ABSTRACT

A disk drive unit comprises a driven turntable (4) having an axis of rotation (5) and including a turntable body (4a) coaxial with the axis of rotation for supporting a disk (D). A first friction layer (13) is provided on the turntable body for engagement with the disk. A disk clamper (7) to be positioned on the disk, comprises a second friction layer (14) for engagement with the disk. The turntable (4) comprises a centring recess (10) and the disk clamper (7) comprises a centring pin fitting into the centring recess. The invention provides a disk drive unit having an improved centring performance, also at high rotational speeds.

### BACKGROUND OF THE INVENTION

The invention relates to a disk drive unit comprising a turntable having an axis of rotation and including a turntable body coaxial with the axis of rotation for supporting a disk, a first friction layer on the turntable body for engagement with the disk, and a disk damper to be positioned on the disk.

Such disk drive unit is known, for example from EP 0 095 800. In this known disk drive unit, the friction layer is formed by a hard rubber ring mounted in a groove of the turntable. Although the friction layer on the turntable keeps the disk longer in a central position on the turntable when the rotational speed is high, the unbalance forces might overcome the friction force between the friction layer and the disk, resulting in an eccentric position of the disk on the turntable. Such eccentric position will reduce the tracking performance of the odd system, will result in additional heat in the tracking actuator and add unbalance to the system causing vibration.

It is an object of the present invention to provide a disk drive unit having an improved centring performance at little cost.

### SUMMARY OF THE INVENTION

The object is achieved by the disk drive unit according to the invention which is characterized in that the disk damper has a second friction layer for engagement with the disk. Advantageous embodiments are defined in the dependent claims.

According to the invention, the friction force on the disk is increased so that the resistance against movement of the disk to an eccentric position is improved. Such additional friction layer does not add much cost to that of the disk drive unit.

It is advantageous if the turntable comprises a first centring member, such as a centring recess, and the disk damper comprises a second centring member, such as a centring pin, engageable with the first centring member. Due to this feature, there is created a very accurate means to keep the disk in a centred position as the damper itself is securely held in a centred position.

Preferably, the first and second friction layers comprise friction rings which conveniently are of similar dimensions and are adapted to engage the disk in substantially the same position.

In a particular embodiment, the turntable body comprises a generally ring shaped centring spring engageable with a central hole in the disk.

This centering spring is able to initially urge the disk into a central position after which the disk is held in this position by the friction layers. Other centering means for the disk are conceivable.

The invention also relates to a device for reading and/or writing data from and/or on, respectively, a disk, provided with the disk drive unit according to the invention.

The invention will be explained in more detail with reference to the drawings showing an exemplary embodiment of the optical disk drive unit according to the invention in a very schematic way.

### BRIEF DESCRIPTION OF THE DRAWINGS

FIG. 1 is a very schematic cross-section of a device for reading and/or writing an optical disk including the disk drive unit according to the invention.

FIG. 2 is a very schematic cross-sectional view of the turntable of the disk drive unit of FIG. 1, on a larger scale.

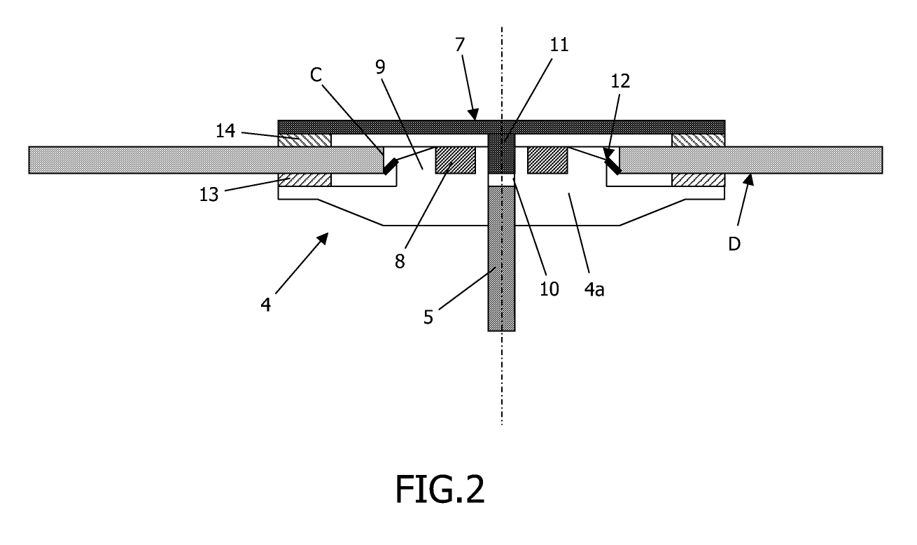

### DETAILED DESCRIPTION OF A PREFERRED EMBODIMENT

The drawings show an embodiment of the disk drive unit. This disk drive unit may be used in a device for reading and/or writing data from or on a disk, such as an optical disk or the like. The device in which this disk drive unit is used may be a portable or a stationary device, such as an audio or video player and/or recorder or a data disk reader and/or writer. The optical disk in this embodiment may be a high speed CD/DVD/Blu-Ray disk or the like. These disks may be rotated at speeds up to 10,000 rpm and higher.

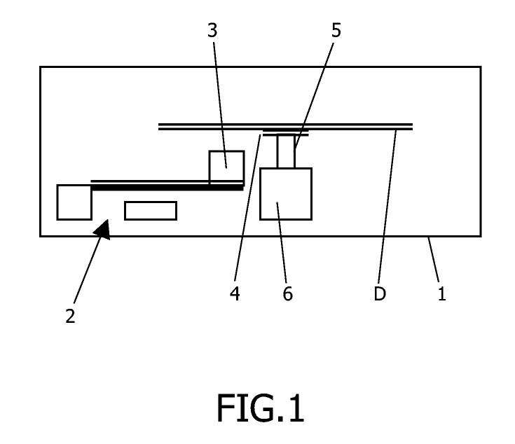

As shown in FIG. 1, the disk drive unit includes a housing 1 accommodating the disk drive unit. The disk drive unit comprises an optical system 2 including an optical pickup unit 3 and a turntable 4 for supporting a disk D. The turntable 4 is rotatably supported by a rotary spindle 5 which is rotatably mounted in a bearing column and forms the axis of rotation for the turntable. The turntable 4 comprises a turntable body 4a which is preferably made of plastic and is attached to the free end of the rotary spindle 5 coaxial with the axis of rotation. Attached to the lower side of the turntable 4 is a rotor which forms part of an electric motor 6.

The turntable 4 cooperates with a (partly) magnetizable metal (steel) damper 7 positioned on a disk D (when it is positioned on the turntable 4) in order to firmly clamp this disk D down on the turntable to stabilise this disk D during rotation of the turntable 4, especially during high rotational speed. The magnetizable damper 7 is designed to cooperate with a clamping magnet 8 which is provided in the turntable 4, in this case within a projecting hub 9 on the turntable 4. The damper 7 may be positioned and shaped such that, in the clamping condition, it approaches the magnet 8 leaving a small gap in between. This results in a sufficient attraction force on the damper 7 on the one hand and in an easy removal of the damper from the disk on the other hand. Due to this latter requirement, the maximum attraction force by the magnet 8 is limited.

To accurately position the damper 7 on the turntable in a central position, the turntable 4 and damper 7 are provided with a first and second centring member, in this case a recess 10 in the turntable 4 and a centring pin 11 on the lower side of the damper 7 accurately fitting into the recess 10. The centring pin 11 is preferably equipped with a chamfer or radius at its tip for improved self centring.

The hub 9 of the turntable 4 projects through a centre hole C in the disk D in order to centre the disk D on the turntable 4. To improve this centring, the hub 9 is provided with a disk centring spring 12 the general diameter of which is slightly larger than the hole C in the disk so that the centring spring exerts an outward force on the circumference of the disk hole C.

A first friction ring 13 is provided on the turntable 4 to ensure that a disk D follows the rotation of the turntable 4, especially during accelerations and high speeds. A second friction ring 14 is provided on the lower side of the damper 7 to double the friction force exerted on the disk D during high speed rotation, thereby preventing movements of the disk to an eccentric position in case of an unbalance force. The first and second friction rings 13, 14 are of equal, or at least similar dimension, so that they engage the disk D in substantially the same position, although on different sides. As a result, they clamp the disk in between them. The material of the friction rings is preferably made of a rubber type, for example Chloroprene rubber (CR).

From the foregoing description it is clear that the invention provides a disk drive unit having an improved disk centring at low cost.

In the presently preferred embodiments, the disk D is an optical data disk. However, it should be understood that the invention can also be used for all kinds of disks, e.g. ferro-electric, magnetic, magneto-optic, optical, near-field, active charge storage disks or other disks using combinations of these techniques or other reading and/or writing techniques.

It is noted that in specification and claims, the use of the expressions “a” or “an” does not exclude a plurality thereof, whereas the expression “comprising” does no exclude additional elements or steps. Any reference signs in the claims shall not be construed as limiting the scope thereof.

The invention is not restricted to the above-described embodiment as shown in the drawing, which can be varied in several ways without departing from the scope of the appended claims. For example, The position and shape of the friction rings, or friction layers with other shapes may be varied. The damper (or a part co-operating with it) may be made partly of a magnetizable material.

1. A disk drive unit comprising a turntable (4) having an axis of rotation (5) and including a turntable body (4a) coaxial with the axis of rotation for supporting a disk (D), a first friction layer (13) on the turntable body for engagement with the disk, and a disk clamper (7) to be positioned on the disk, said disk clamper having a second friction layer (14) for engagement with the disk.

2. The disk drive unit of claim 1, wherein the turntable (4) comprises a first centring member (10) and the disk clamper (7) comprises a second centring member (11) engageable with the first centring member.

3. The disk drive unit of claim 2, wherein the first centring member (10) comprises a centring recess and the second centring member (11) comprises a centring pin fitting into the centring recess.

4. The disk drive unit of claim 1, wherein the first friction layer (13) comprises a friction ring.

5. The disk drive unit of claim 1, wherein the second friction layer (14) comprises a friction ring.

6. The disk drive unit of claim 1, wherein the first and second friction layers (13, 14) have similar dimensions and are adapted to engage the disk (D) in substantially the same position.

7. The disk drive unit of claim 1, wherein the turntable body comprises a generally ring shaped centring spring (12) engageable with a central hole (C) in the disk (D).

8. A device for reading and/or writing data from and/or on, respectively, a disk, provided with the disk drive unit according to claim 1.
